(19) United States
(12) Patent Application Publication
(10) Pub. No.: US 2009/0020140 A1
(43) Pub. Date: Jan. 22, 2009

(54) NON-FLAMMABLE SOLVENTS FOR SEMICONDUCTOR APPLICATIONS

(75) Inventors: Zhiwen WAN, Plano, TX (US); Ashutosh Misra, Plano, TX (US); Ziyun Wang, Allen, TX (US)

Correspondence Address: AIR LIQUIDE;Intellectual Property, 2700 POST OAK BOULEVARD, SUITE 1800, HOUSTON, TX, 77056, US

(73) Assignee: AIR LIQUIDE ELECTRONICS U.S. LP, Houston, TX (US)

(21) Appl. No.: 12/135,699

(22) Filed: Jun. 9, 2008

Related U.S. Application Data
(60) Provisional application No. 60/944,710, filed on Jun. 18, 2007.
(60) Provisional application No. 60/942,551, filed on Jun. 7, 2007.

(51) Int. Cl. B08B 3/10; B08B 3/08

(52) U.S. Cl. 134/13; 134/22.14; 134/21

(57) ABSTRACT

Methods and compositions for purging and cleaning a semiconductor fabrication system are disclosed herein. In general, the disclosed methods utilize solvents comprising hydrofluoroethers. Hydrofluoroethers are non-toxic and have low moisture content, preventing heat generation from organometallic precursor hydrolysis. In an embodiment, a method of cleaning a semiconductor fabrication system comprises dissolving at least one chemical precursor used in semiconductor fabrication in at least one delivery line with a solvent to clean the at least one delivery line. The solvent generally comprises a hydrofluoroether. The methods and compositions may be used in a variety of semiconductor film deposition processes.

### CROSS-REFERENCE TO RELATED APPLICATIONS

The present application claims the benefit of U.S. Provisional Application Ser. No. 60/944,710, filed Jun. 18, 2007 and U.S. Provisional Application Ser. No. 60/942,551, filed Jun. 7, 2007, herein incorporated by reference in their entireties for all purposes.

### BACKGROUND

1. Field of the Invention

This invention relates generally to the field of semiconductor fabrication. More specifically, the invention relates to new solvents for use in semiconductor fabrication.

2. Background of the Invention

Organometallic precursors and inorganic chemicals are used in semiconductor fabrication using chemical vapor deposition (CVD) or atomic layer deposition (ALD) techniques. Many of these precursors are extremely sensitive to air and decompose rapidly in the presence of oxygen, water, or high temperature. The decomposition products contaminate the deposition chambers and delivery lines. In addition, most of the organometallic CVD precursors used in semiconductor fabrication are flammable or pyrophoric, and are moisture sensitive. The precursors may react with moisture and result in the production of heat and the formation of flammable organic by-products. Current solvents used in semiconductor process for cocktail, the precursor delivery system purging and canister residue rinsing are alkanes, such as octane and hexane, which are highly flammable. These solutions of alkanes and organometallic precursors represent a great flammable hazard in semiconductor fabrication.

Consequently, there is a need for non-toxic and non-flammable solvents for organometallic precursors in semiconductor fabrication.

### BRIEF SUMMARY

Compositions and methods for cleaning semiconductor fabrication systems utilizing hydrofluoroethers are described herein. Hydrofluoroethers are a safer alternative to solvents presently being used in the industry. Not only are hydrofluoroethers safer, but they also meet other criteria for an effective cleaning solvent. In particular, hydrofluoroethers reduce the flammable and corrosive hazards involved with using organometallic precursors. Hydrofluoroethers are non-toxic and non-environment damage solvent and have low moisture content, preventing heat generation from organometallic precursor hydrolysis. Accordingly, use of hydrofluoroethers in semiconductor fabrication systems may significantly reduce fire hazards. Additionally, with the increasing cost of hydrocarbons, use of hydrofluoroethers may provide a more cost-effective alternative to present hydrocarbon solvents. Thus, utilizing hydrofluoroethers in a semiconductor fabrication system may present several advantages over existing solvents.

In an embodiment, a method of cleaning a semiconductor fabrication system comprises dissolving at least one chemical precursor used in semiconductor fabrication in one or more delivery lines with a solvent to clean the one or more delivery lines. The solvent comprises a hydrofluoroether.

In an embodiment, a method of removing one or more chemical precursors used in semiconductor fabrication from at one or more delivery lines in a semiconductor fabrication system comprises forcing a solvent containing a hydrofluoroether through the one or more delivery lines. The method also comprises dissolving the one or more chemical precursors in the solvent to remove the one or more chemical precursors from the one or more delivery lines.

In another embodiment, a method of preventing corrosion in one or more delivery lines in a semiconductor fabrication system comprises using hexachlorodisilane as a chemical precursor for film deposition in the semiconductor fabrication system. The method further comprises flushing the one or more delivery lines with a solvent containing a hydrofluoroether. In addition, the method comprises dissolving the hexachlorodisilane with the solvent to remove the hexadichlorosilane from the semiconductor fabrication system and prevent corrosion.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### Notation and Nomenclature

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . .”. Also, the term “couple” or “couples” is intended to mean either an indirect or direct chemical bond. Thus, if a first molecule couples to a second molecule, that connection may be through a direct bond, or through an indirect bond via other functional groups or bonds. The bonds may be any known chemical bonds such as without limitation, covalent, ionic, electrostatic, dipole-dipole, etc.

As used herein, the term “alkyl group” refers to saturated functional groups containing exclusively carbon and hydrogen atoms. Further, the term “alkyl group” refers to linear, branched, or cyclic alkyl groups. Examples of linear alkyl groups include without limitation, methyl groups, ethyl groups, propyl groups, butyl groups, etc. Examples of branched alkyls groups include without limitation, t-butyl. Examples of cyclic alkyl groups include without limitation, cyclopropyl groups, cyclopentyl groups, cyclohexyl groups, etc.

As used herein, the abbreviation, “Me,” refers to a methyl group; the abbreviation, “Et,” refers to an ethyl group; the abbreviation, “Pr,” refers to a propyl group; and the abbreviation.

### DETAILED DESCRIPTION OF THE PREFERRED EMBODIMENTS

In an embodiment, a method of cleaning a semiconductor fabrication system comprises flushing or purging the system with a solvent comprising one or more hydrofluoroethers. As used herein, the term “flush” may refer to rinsing and/or purging the components of a semiconductor fabrication system with one or more of the disclosed compositions described herein. More particularly, the method uses the hydrofluoroether-containing solvent to dissolve one or more residual chemical precursors in a delivery line of a semiconductor fabrication system. As used herein. The term “precursor(s)” may refer to compounds used to deposit films in semiconductor fabrication. Hydrofluoroethers are non-toxic and non-environment damage solvent and have less than 10 ppm moisture content. Without being limited to theory, the low moisture content and low volatility of the hydrofluoroethers may prevent and reduce heat generation from organometallic precursor hydrolysis. After flammable or pyrophoric precursors are diluted in hydrofluoroethers, the risk of fire has been substantially eliminated. Accordingly, hydrofluoroethers may be used to reduce flammability of residual precursors after a semiconductor fabrication process. Preferably, the hydrofluoroethers used in embodiments of the disclosed method have a moisture content no more than 10 ppm, alternatively no more than about 5 ppm, alternatively no more than about 1 ppm. Hydrofluoroethers having a moisture content no more than about 10 ppm may be referred to as ultrapure hydrofluoroethers. In addition, the hydrofluoroether may have a boiling point below 100° C.

As used herein, hydrofluoroethers may refers to highly fluorinated chemical compounds containing carbon, fluorine, hydrogen, one or more ether oxygen atoms, and optionally one or more additional catenary heteroatoms within the carbon backbone, such as sulfur or nitrogen. The hydrofluoroether within the solvent may be any suitable hydrofluoroether known to those of skill in the art. In general, the hydrofluoroether may be straight-chained, branched-chained, or cyclic, or a combination thereof, such as alkylcycloaliphatic. Preferably, the hydrofluoroether is saturated or free of double bonds. These fluorinated ethers may generally be depicted by the formula:

R₁—O—R₂ (1)

where R₁ and R₂ may be the same or are different from one another and may be alkyl, aryl, and alkylaryl groups. At least one of R₁ and R₂ contains at least one fluorine atom, and at least one of R₁ and R₂ contains at least one hydrogen atom. R₁ and R₂ may also be linear, branched, or cyclic, and may contain one or more unsaturated carbon-carbon bonds. R₁ and R₂ may also comprise fluoroalkyl groups having from 1 to 5 carbon atoms.

In at least one embodiment, the hydrofluoroether may be represented by the following formula:

R₁—O—CH₃ (2)

where, as shown in formula (2) above, R₁ may be a linear or branched perfluoroalkyl group having from 1 to 4 carbon atoms. Preferably, the perfluoroalkyl group has 4 carbon atoms. The hydrofluoroether may be a mixture of hydrofluoroether having linear or branched perfluoroalkyl R₁ groups. For example, the solvent may comprises perfluorobutyl methyl ether containing about 95 weight percent perfluoro-n-butyl methyl ether and 5 weight percent perfluoroisobutyl methyl ether and perfluorobutyl methyl ether containing about 60 wt % to about 80 wt % perfluoroisobutyl methyl ether and about 40 wt % to about 20 wt % perfluoro-n-butyl methyl ether are useful in this invention. Examples of such hydrofluoroethers are described in detail in U.S. Pat. No. 5,827,812, incorporated herein by reference in its entirety for all purposes. In an exemplary embodiment, hydrofluoroether solvent having a hydrofluoroether with the formula shown in (2) is HFE-7100 (commercially available from 3M® Company, Minneapolis, Minn.).

According to another embodiment, the hydrofluoroether may be represented by the following formula:

R₁—O—C₂H₅ (2)

where, as shown in the formula (3) above, R₁ is selected from the group consisting of linear or branched perfluoroalkyl groups having 1 to 4 carbon atoms. Preferably, the perfluoroalkyl group has 4 carbon atoms. The hydrofluoroether solvent may be a mixture of hydrofluoroethers having linear or branched perfluoroalkyl R₁ groups. For example, the solvent may contain a perfluorobutyl ethyl ether containing about 95 wt % perfluoro-n-butyl ethyl ether and 5 wt % perfluoroisobutyl ethyl ether and perfluorobutyl ethyl ether containing about 15 wt % to about 35 wt % perfluoroisobutyl ethyl ether and about 85 wt % to about 65 wt % perfluoro-n-butyl ethyl ether may also be useful. Examples of such hydrofluoroethers are described in detail in U.S. Pat. No. 5,814,595, incorporated herein by reference in its entirety for all purposes. In an exemplary embodiment, the hydrofluoroether solvent is HFE-7200 (commercially available from 3M® Company, Minneapolis, Minn.).

The solvent may comprise a concentration of hydrofluoroether having at least about 50 wt % hydrofluoroether, alternatively having at least about 90 wt % hydrofluoroether, alternatively having at least about 99 wt % hydrofluoroether. According to one embodiment, the solvent comprises at least 95% hydrofluoroether by weight, and more preferably at least 99% hydrofluoroether by weight. Furthermore, the solvent may be a mixture of more than one hydrofluoroether. By way of example only, about 50% by weight of the solvent may comprise perfluorobutyl ethyl ether and about 50% by weight of the solvent may comprise perfluorobutyl methyl ether.

In other embodiments, the solvent comprises a mixture of a hydrofluoroether and other solvents. Examples of other solvents include without limitation, hydrocarbons or alkanes (e.g pentanes, hexanes, octanes, heptanes, etc.), ethers (e.g. diethylethers, tetrahydrofuran), amines (e.g. triethylamine), ketones (e.g. acetone), and alcohols (e.g. iso-propylalcohol), dichloromethane, aromatics, etc. In one embodiment, the solvent mixture comprises about 50% by weight hydrofluoroether and about 50% by weight of other solvents.

The disclosed solvent compounds may utilized in conjunction with an deposition methods known to those of skill in the art. Examples of suitable deposition methods include without limitation, conventional CVD, low pressure chemical vapor deposition (LPCVD), atomic layer deposition (ALD), pulsed chemical vapor deposition (P-CVD), plasma enhanced atomic layer deposition (PE-ALD), or combinations thereof. The semiconductor fabrication system may include a reaction chamber. The reaction chamber may be any enclosure or chamber within a device in which deposition methods take place such as without limitation, a cold-wall type reactor, a hot-wall type reactor, a single-wafer reactor, a multi-wafer reactor, or other types of deposition systems under conditions suitable to cause semiconductor film deposition.

The present hydrofluoroether solvent compositions are capable of cleaning the surfaces of a semiconductor fabrication system, which are typically made of metal such as stainless steel. In addition, the solvent compositions disclosed herein are capable of cleaning the surfaces of any materials used in semiconductor fabrication systems. The disclosed solvent compositions containing hydrofluoroethers are capable of dissolving the residues left by organometallic compounds and inorganic chemicals that are used in semiconductor fabrication. Examples of such compounds include without limitation, transition metal complexes of Ti, Ta, Nb, Hf. Si, La, Ru, Pt, Cu, etc. Examples of transition metal complexes include without limitation, titanium chloride, hafnium chloride, titanium amide complexes, hafnium amides, tantalum amides, silicon amides, La(trimethylsilylacetylene), ruthenium alkyls, triethoxyboron (TEB), triethylphosphite (TEPO), trimethylphosphite (TMPO), or combinations thereof. Other precursors that may be dissolved with the disclosed solvents include without limitation, any silicon precursor, silicon alkylamide, silicon alkyloxide, disilane compounds, metal/metal-oxide precursors, alkyl metals (pyrophoric), metal Cp complex, metal CO complex, metal alkyloxide, metal dialkylamide, etc. Furthermore, the disclosed hydrofluoroether solvents are substantially inert to these chemical precursors. In other words, the solvent does not react with the chemical precursor or its residue to form additional contaminating compounds. In addition, the disclosed hydrofluoroether solvents significantly reduce the flammability and fire hazard present in existing hydrocarbon solvents.

In one embodiment, the hydrofluoroether solvent may specifically be used to remove a hexachlorodisilane precursor. Hexachlorodisilane (HCDS), Si₂Cl₆ is a compound with a silicon silicon bond. HCDS may be a potential CVD precursor for silicon thin films, such as silicon nitride (SiN), silicon dioxide (SiO₂), polycrystalline and monocrystalline silicon (Si). The silicon thin films may be used as spacer nitride, spacer oxide, etch stop, cap nitride, STI liner, gapfill, engineered source/drain and engineered substrates. It is also a precursor for synthesis of disilane (Si₂H₆), another CVD Si container film precursor.

HCDS is a highly reactive compound, which rapidly reacts with water or moisture in air to form corrosive acid (e.g. HCl). The hydrochloric acid formed from the reaction with water and HCDS may cause severe corrosion on the metal surfaces of the semiconductor fabrication system. Thus, a method of preventing corrosion in semiconductor fabrication systems which use HCDS as a chemical precursor may comprise flushing the semiconductor fabrication system with a hydrofluoroether solvent. The hydrofluoroether solvent dissolves residual HCDS and removes the HCDS from the system to prevent formation of corrosive HCl.

Incomplete or partial hydrolysis of HCDS forms hazardous gel by-products also known as “poppy gels,” which are also highly flammable. As such, proper solvent rinse and purge sequences with a non-flammable hydrofluoroether solvent may be used to completely remove HCDS residual after a deposition operation. Use of hydrofluoroethers are preferable over existing flammable hydrocarbon solvents. Any solid residue or poppy gel formed by a spill or improper operation with HCDS may also be cleaned by using an embodiment of the disclosed hydrofluoroether solvents.

In one embodiment, a method of removing at least one chemical precursor from a semiconductor fabrication system comprises forcing a solvent containing at least one hydrofluoroether through the semiconductor fabrication system. Forcing an hydrofluoroether solvent through the fabrication system serves to remove or dissolve any chemical precursors or residue remaining after a fabrication process. As the hydrofluoroether solvent contacts the metal surfaces of the system, it dissolves any chemical precursor residue remaining in the system. The solvent preferably is in contact with the metal surfaces of the system for a time sufficient to dissolve all of the residual chemical precursors. Typically, the solvent is flushed through the lines at a flow rate ranging from about 0.1 to about 5 standard liters/min. The flushed solvent is either removed through the exhaust dry pump if it is present in small quantities or it can be collected in a solvent waste canister on the tool for disposal periodically.

In embodiments of the method to remove a chemical precursor (i.e. HCDS), after a purge/rinse cycle with one or more hydrofluoroether solvents, the resulting precursor/hydrofluoroether purge solution may slowly be added to a dilute base solution under N₂ environment to raise the pH level. For example, the pH may be raised to about 8. The base may be any suitable base such as without limitation, NaOH, CaOH, KOH, and the like. The hydrofluoroether solvent may be separated from aqueous solution and purified with moisture adsorption column/filter and recycled for another purge/rinse cycle.

The present methods may be incorporated in any solvent purging process or sequence generally known to those of ordinary skill in the art. For example, in a typical solvent purging sequence, the valves from the chemical precursor storage container are first shut off. A solvent purge operation is then initiated, in which a hydrofluoroether solvent from a solvent tank or canister is flushed or pumped through the fabrication system. Generally, a fabrication system comprises many components including without limitation, the chemical delivery cabinet, one or more delivery lines where the precursor has wetted the surface, the intermediate valves, the mass flow controllers, the vaporizer on the wafer manufacturing system, and the like. As solvent passes through the various components of the fabrication system, it dissolves the residual chemical precursors and removes them from the system. The solvent purge operation may be completely automated or performed manually. The hydrofluoroether solvent composition is flushed or forced through a fabrication system by pressurizing a solvent with an inert gas, for example N₂ or He, and then using vacuum to dry the residual solvent in the lines.

After forcing the solvent through the system, the solvent is removed from the system along with the chemical precursors or residue dissolved therein. Complete removal of the solvent can be accomplished by evaporating the solvent under vacuum. Alternatively, nitrogen or some other inert gas may be blown through the system to dry the hydrofluoroether solvent. Generally, the system is repeatedly flushed and dried at least 10 times, preferably 20 times, more preferably 30 times. Moreover, in other embodiments, the semiconductor fabrication system is flushed and dried such that a desired base pressure of 10⁻⁷ to 10⁻⁹ torr is achieved where approximately less than 10 ppm of chemical precursor remains in the system.

In general, the hydrofluoroether is used to clean the delivery lines of a semiconductor or thin film fabrication system. However, the hydrofluoroether may be used to clean any containers, chambers, tools, or valves in the system that are in contact with chemical precursors that are prone to decomposition in the presence of air. A semiconductor fabrication system includes any part, line, valve, chamber, process tool, container involved in manufacturing semiconductors. Examples of semiconductor fabrication systems include without limitation, chemical vapor deposition systems, thin film fabrication systems, atomic layer deposition systems, and the like.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims.

The discussion of a reference is not an admission that it is prior art to the present invention, especially any reference that may have a publication date after the priority date of this application. The disclosures of all patents, patent applications, and publications cited herein are hereby incorporated herein by reference in their entirety, to the extent that they provide exemplary, procedural, or other details supplementary to those set forth herein.

What is claimed is:

1. A method of cleaning a semiconductor fabrication system comprising:
flushing the semiconductor fabrication system by dissolving one or more chemical precursors used in semiconductor fabrication in one or more delivery lines with a solvent to clean the one or more delivery lines, wherein the solvent comprises a hydrofluoroether.

2. The method of claim 1, wherein the hydrofluoroether comprises the formula:
R₁—O—R₂
wherein R₁ is a perfluoroalkyl group having from 1 to 4 carbon atoms, wherein the perfluoroalkyl group is branched or linear, and R₂ is an alkyl group having from 1 to 2 carbon atoms.

3. The method of claim 2 wherein R₁ comprises 4 carbon atoms.

4. The method of claim 2 wherein R₂ is a methyl group.

5. The method of claim 2 wherein R₂ is an ethyl group.

6. The method of claim 1, wherein the hydrofluoroether comprises perfluorobutyl methyl ether, perfluorobutyl ethyl ether, or combinations thereof.

7. The method of claim 1 wherein the hydrofluoroether comprises less than about 10 ppm water.

8. The method of claim 1 wherein the solvent comprises a mixture of the hydrofluoroether and an organic solvent.

9. The method of claim 8 wherein the organic solvent is selected from the group consisting of dichloromethane, acetone, chloroform, pentane, hexane, heptane, octane, or ethyl ether.

10. The method of claim 1, further comprising drying the solvent from the system by reducing the pressure therein below atmospheric pressure.

11. The method of claim 10, further comprising drying the system such that less than about 10 ppm of the one or more chemical precursors remains in the system.

12. The method of claim 10, further comprising flushing and drying the system more than once.

13. The method of claim 1, further comprising separating the one or more chemical precursors from the solvent and recycling the solvent.

14. A method of removing one or more chemical precursors used in semiconductor fabrication from one or more delivery lines in a semiconductor fabrication system comprising:
a) forcing a solvent containing a hydrofluoroether through the one or more delivery lines; and
b) dissolving the one or more chemical precursors in the solvent to remove the one or more chemical precursors from the one or more delivery lines.

15. The method of claim 14, further comprising removing the solvent from the semiconductor fabrication system.

16. The method of claim 14 wherein the hydrofluoroether comprises the formula:
R₁—O—R₂
wherein R₁ is a perfluoroalkyl group having from 1 to 4 carbon atoms, wherein the perfluoroalkyl group is branched or linear, and R₂ is an alkyl group having from 1 to 2 carbon atoms.

17. The method of claim 14 wherein R₁ is a perfluorobutyl group.

18. The method of claim 14 wherein R₂ is a methyl group or an ethyl group.

19. The method of claim 14 wherein the hydrofluoroether comprises perfluorobutyl methyl ether, perfluorobutyl ethyl ether, or combinations thereof.

21. The method of claim 14 wherein the one or more chemical precursors comprises an organometallic compound, a silicon precursor, or combinations thereof.

22. The method of claim 14 wherein the one or more chemical precursors comprises hexachlorodisilane.

23. The method of claim 14 wherein a purge solution comprising the one or more chemical precursors dissolved in the solvent is formed in (b), and further comprising separating the solvent from the one or more chemical precursors and recycling the solvent for use in (a).

24. The method of claim 23, further comprising raising the pH of the purge solution before separating the solvent from the one or more chemical precursors.

25. The method of claim 14 wherein the solvent comprises a mixture of different hydrofluoroethers.

26. The method of claim 14 wherein the solvent comprises a mixture of a hydrofluoroether and an organic solvent.

27. The method of claim 26 wherein the organic solvent is selected from the group consisting of dichloromethane, acetone, chloroform, pentane, hexane, heptane, octane, or ethyl ether

28. The method of claim 14 wherein the hydrofluoroether comprises less than about 10 ppm water.

29. A method of preventing corrosion in one or more delivery lines in a semiconductor fabrication system comprising:
a) using hexachlorodisilane as a chemical precursor for film deposition in the semiconductor fabrication system;
b) flushing the one or more delivery lines with a solvent containing a hydrofluoroether; and
c) dissolving the hexachlorodisilane with the solvent to remove the hexadichlorosilane from the semiconductor fabrication system and prevent corrosion.

30. The method of claim 29 wherein the hydrofluoroether comprises perfluorobutyl methyl ether, perfluorobutyl ethyl ether, or combinations thereof.
